(19) United States
(12) Patent Application Publication
(10) Pub. No.: US 2005/0160085 A1
(43) Pub. Date: Jul. 21, 2005

(54) Information processing method, information processing terminal, program, and computer-readable storage medium

(75) Inventors: Shuji Ichikawa, Kawasaki (JP); Yuji Kobayashi, Kawasaki (JP); Tomonori Kudo, Yokohama (JP); Daiki Suzuki, Kawasaki (JP); Masashi Takizawa, Yokohama (JP); Koji Maekawa, Kawasaki (JP); Ken-ichi Abe, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/014,989

(22) Filed: Dec. 20, 2004

(30) Foreign Application Priority Data
Dec. 24, 2003 (JP) 2003-427618
Jun. 15, 2004 (JP) 2004-177057

(51) Int. Cl. G06F 7/00

(52) U.S. Cl. 707/3

(57) ABSTRACT

A distribution service to relay distributed information search is searched for (S6001). If no distribution service is detected, the distribution service is dynamically activated from the self host (S6003). Relay of search request information from remaining hosts is started, and the remaining hosts are registered in the management information (S6005).

### FIELD OF THE INVENTION

The present invention relates to an information processing technique for a plurality of terminals on a network and, for example, to a technique of searching information distributed to the terminals.

### BACKGROUND OF THE INVENTION

As a search processing method, there is a centralized administration type search service in which an apparatus generates search indexes of information stored in each of other apparatuses, and it processes a search request received from another apparatus, and sends the search result to the apparatus at the request source. In recent years, a distributed administration type search service has also been implemented in which a search service is arranged in each apparatus connected to a network. Each apparatus which has received a search request executes search processing and transmits the search result to the apparatus at the request source.

Various methods are used to present search results output from a plurality of search servers to the operator. For example, a summary is generated from each text and output as part of the search result. Alternatively, if pieces of information having the same contents are contained in the search result, they are output as a single search result. However, to execute these processing operations, resources such as the CPU and memory in an apparatus are necessary. Hence, when these functions are executed, a heavy load may be exerted on the apparatus requested of the search depending on its performance.

Even when these functions are executed by a server which executes relay between a user-side client terminal and a search server which executes search processing in distributed search, a heavy load may be exerted on the apparatus depending on its performance.

Assume that a search result integration service is provided by a specific apparatus on the network, and the search result integration service is implemented by transmitting a distributed search result to the specific apparatus. In this case, the search result notification cannot be implemented if the specific apparatus does not participate in the network.

### SUMMARY OF THE INVENTION

The present invention has been made in consideration of the above-described problems, and has as its object to provide a technique to implement operability without cumbersome setup operation by a user who executes search processing and the system administrator by using an existing service when a distributed search relay apparatus for executing a search request information distribution service by a plurality of terminals distributed on a network is already present or by dynamically activating the service even when no distribution service is present.

It is another object of the present invention to provide a technique to make it possible to present a search result to the operator even when a specific apparatus does not participate in the network, with reducing load of own apparatus.

In order to achieve an object of the present invention, for example, an information processing method of the present invention comprises the following arrangement.

That is, an information processing method executed by, of a plurality of terminals present on a network, a terminal which receives a predetermined processing request, comprising:
a search step of searching for a terminal capable of executing the predetermined processing; and
a step of causing the terminal which has received the predetermined processing request to execute the predetermined processing by itself when no terminal capable of executing the predetermined processing is detected in the search step.

In order to achieve an object of the present invention, for example, an information processing terminal of the present invention comprises the following arrangement.

That is, an information processing terminal which receives a predetermined processing request in a plurality of terminals present on a network, comprising:
a search device which outputs a message to search for a terminal capable of executing the predetermined processing; and
a processing device which causes the terminal which has received the predetermined processing request to execute the predetermined processing by itself when no terminal capable of executing the predetermined processing is detected by the search device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the arrangement of a distributed information search apparatus according to an embodiment of the present invention;

FIG. 2 is a view showing the arrangement of a network by the distributed information search apparatus according to the embodiment of the present invention;

FIG. 3 is a view showing a host information management table according to the embodiment of the present invention;

FIG. 4 is a view showing a distributed information search request message according to the embodiment of the present invention;

FIG. 5 is a view showing the distributed information search request message according to the embodiment of the present invention;

FIG. 6 is a view showing the distributed information search request message according to the embodiment, of the present invention;

FIG. 7 is a flowchart showing distributed information search processing by a first transmission method executed in the embodiment of the present invention;

FIG. 8 is a flowchart showing search request transmission path determination processing by the first transmission method executed in the embodiment of the present invention;

FIG. 9 is a flowchart showing search request transmission processing by the first transmission method executed in the embodiment of the present invention;

FIG. 10 is a flowchart showing search response reception processing executed in the embodiment of the present invention;

FIG. 11 is a flowchart showing search request reception processing by a second transmission method executed in the embodiment of the present invention;

FIG. 12 is a flowchart showing distributed search path selection service activation processing executed in the embodiment of the present invention;

FIG. 13 is a flowchart showing distributed search request transmission method determination processing executed in the embodiment of the present invention;

FIG. 14 is a flowchart showing search request reception processing by the second transmission method executed in the embodiment of the present invention;

FIG. 15 is a flowchart showing distributed search request transmission method determination processing executed in the embodiment of the present invention;

FIG. 16 is a block diagram showing the network arrangement of an information processing apparatus according to the embodiment of the present invention;

FIG. 17 is a block diagram showing the arrangement of the information processing apparatus according to the embodiment of the present invention;

FIG. 18 is a flowchart showing a detailed flow of network participation processing in the information processing apparatus according to the embodiment of the present invention;

FIG. 19 is a flowchart showing a detailed flow of search processing in the information processing apparatus according to the embodiment of the present invention;

FIG. 20 is a flowchart showing a detailed flow of search result integration processing in the information processing apparatus according to the embodiment of the present invention;

FIG. 21 is a flowchart showing a detailed flow of search result display processing in the information processing apparatus according to the embodiment of the present invention;

FIG. 22 is an explanatory view showing the storage area of search result integration device information in the information processing apparatus according to the embodiment of the present invention;

FIG. 23 is an explanatory view showing the storage area of search result information in the information processing apparatus according to the embodiment of the present invention; and

FIG. 24 is an explanatory view showing a search result display window in the information processing apparatus according to the embodiment of the present invention.

### DETAILED DESCRIPTION OF THE PREFERRED EMBODIMENTS

Preferred embodiments of the present invention will now be described in detail in accordance with the accompanying drawings.

### First Embodiment

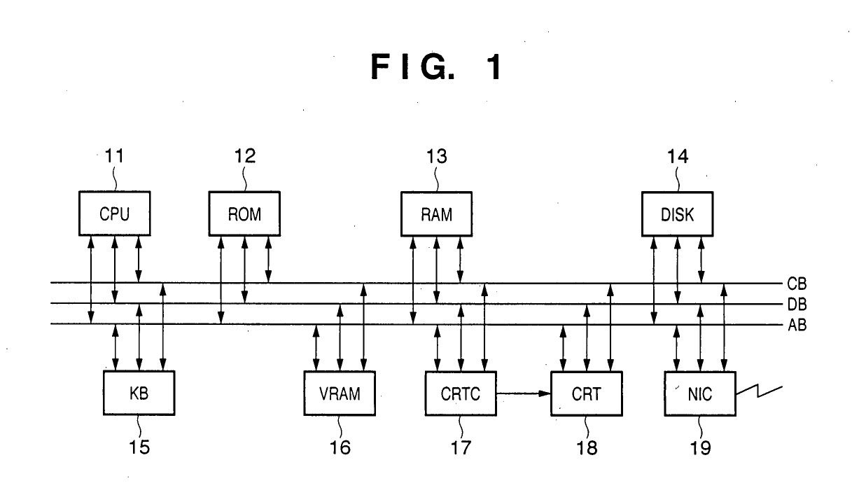

FIG. 1 is a view showing the arrangement of each distributed information search apparatus on a network according to an embodiment.

Referring to FIG. 1, a microprocessor (CPU) 11 executes operations and logic determinations for distributed information search and controls constituent elements connected to an address bus AB, control bus CB, and data bus DB through these buses.

The address bus AB transfers an address signal which designates a constituent element to be controlled by the CPU 11. The control bus CB transfers a control signal for a constituent element to be controlled. The data bus DB executes data transfer between the devices.

A read only memory (ROM) 12 stores the control program codes of a processing program and the like to be executed in this embodiment.

A writable random access memory (RAM) 13 is used to temporarily store various kinds of data from the constituent elements.

An external memory (DISK) 14 stores search target information. As the storage medium which stores the data and programs, a ROM, floppy (registered trademark) disk, CD-ROM, DVD-ROM, memory card, magnetooptical disk, or the like can be used.

A keyboard (KB) 15 comprises various kinds of function keys such as alphabet keys, hiragana keys, katakana keys, symbol input keys for punctuation marks, search key to instruct search, and cursor keys to instruct cursor movement.

A display video memory (VRAM) 16 stores patterns of data to be displayed.

A CRT controller (CRTC) 17 displays, on a display device (CRT) 18, contents stored in the display video memory (VRAM) 16.

The display device (CRT) 18 comprises a cathode ray tube or liquid crystal panel. Dot display patterns and cursor display on the display device (CRT) 18 are controlled by the CRT controller 17.

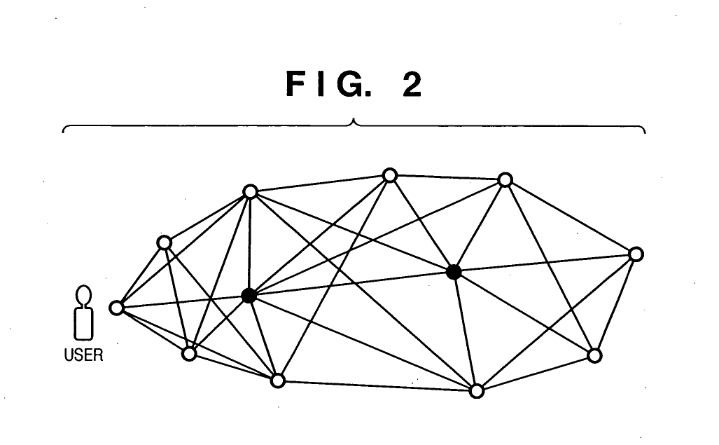

A network controller (NIC) 19 is connected to the network and connects a plurality of host computers (to be described later in FIG. 2).

The distributed information search apparatus including the above-described constituent elements operates in accordance with various kinds of inputs from the keyboard (KB) 15 or various kinds of inputs supplied from the network controller through the network. When an input is supplied from the keyboard (KB) 15 or network controller 19, first, an interrupt signal is sent to the microprocessor (CPU) 11. The microprocessor (CPU) 11 reads out various kinds of control signals stored in the external memory (DISK) 14. Various kinds of control are executed in accordance with the control signals.

The present invention is also achieved by supplying a storage medium which stores the program of the embodiment to a system or apparatus, and causing the computer of the system or apparatus to read out and execute the program codes stored in the storage medium.

The arrangement of a network to which a plurality of distributed information search apparatuses of this embodiment are connected will be described next with reference to FIG. 2.

FIG. 2 shows the arrangement of the network to which a plurality of distributed information search apparatuses of this embodiment are connected.

Referring to FIG. 2, open and filled circles indicate terminals serving as network nodes which have a common network address and form a subnet. Each open circle indicates a distributed information search apparatus having the arrangement descried in detail with reference to FIG. 1. The distributed information search apparatus holds a search service which has a function of searching for a distributed search relay apparatus, transmitting a user's search request to the distributed search relay apparatus after detection, executing search processing for search request information transmitted from the distributed search relay apparatus, and returning the search processing result to a designated terminal such as the distributed search relay apparatus. Each filled circle indicates a distributed search relay apparatus having the arrangement descried in detail with reference to FIG. 1. The distributed search relay apparatus holds a relay service which executes location management of the plurality of distributed information search apparatuses holding the search service and existing on the network, distributes a search request from a distributed information search apparatus to the distributed information search apparatuses under the location management, and returns search results returned from the distributed information search apparatuses together to the distributed information search apparatus which has issued the search request. The distributed information search apparatus indicated by a filled circle holds the relay service to select a distributed search path and distributes a search request and can also hold the search service.

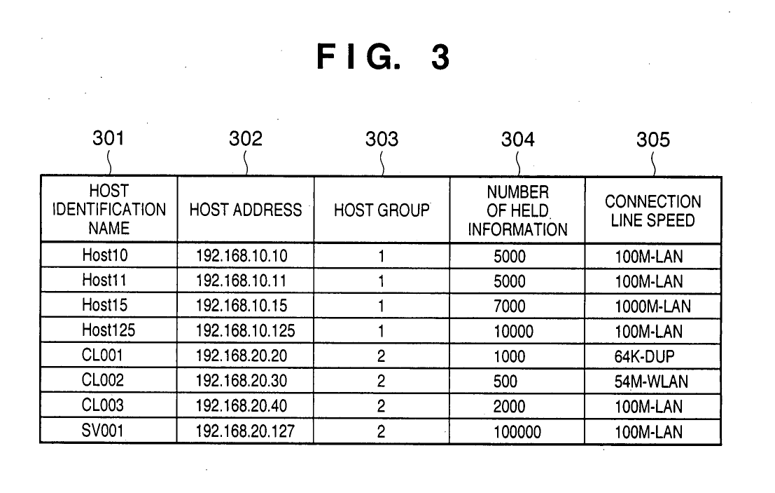

FIG. 3 is a view showing an example of the structure of management information of a distributed information search apparatus (to be simply referred to as a host hereinafter) to which search request information is to be transmitted in the distributed information search apparatus according to the embodiment. The host management information is stored in the RAM 13 or DISK 14 in FIG. 1.

Referring to FIG. 3, a host identification name 301 stores the name of each host as an ASCII character string. The host identification name can acquire a corresponding host address (IP address) by DNS (Domain Name System).

In this embodiment, a host address 302 stores a 32-bit IP address which uniquely indicates each host.

A host group 303 stores an identifier which puts hosts having a common network address and belonging to the same subnet into a group and identifies each group.

A number 304 of held information indicates the total number of search target data (files) searchable by each host. The data are stored in the DISK 14 shown in FIG. 1. In this embodiment, the number of information is the number of files on the file system to be searched.

The host management information in FIG. 3 is held by information exchange upon autonomous connection establishment between the hosts before distributed information search. Alternatively, the host management information is explicitly given by the system administrator for each host.

A connection line type 305 of each host to the network stores the information of the line speed and line type.

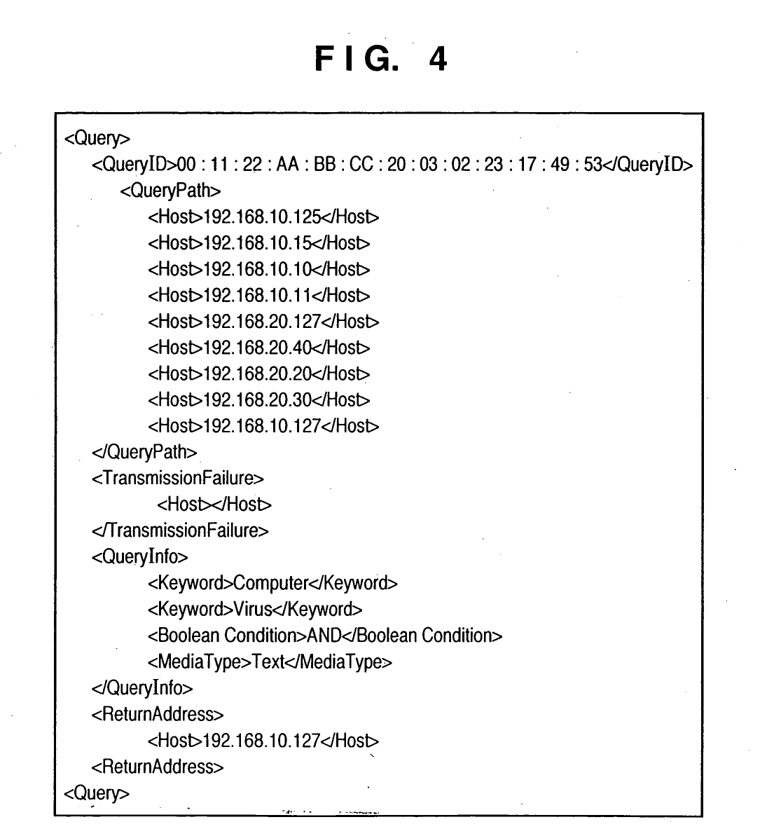

FIG. 4 is a view showing an example of the structure of search request information transmitted to each host in the distributed information search network according to the embodiment of the present invention shown in FIG. 2. FIG. 4 shows a message representing that search request information received by a host having a host address “192.168.10.127” is transmitted to “Host125” having a host address “192.168.10.125”.

In this embodiment, the search request information is described by a text marked up by tags. Referring to FIG. 4, the message is described by an XML document in which an integer string sandwiched between < > and </> indicates an element of the search request information.

Referring to FIG. 4, <Query> is an element tag serving as the root of the search request information. A piece of search request information has only one <Query> element.

<QueryID> is an element tag representing identification information which uniquely identifies the search request information. The identification information of search request information is generated by the combination of the MAC address unique to the host which has created the search request information and the information of the time when the host has created the search request information.

<QueryPath> is an element tag which specifies a host to which the search request information should be distributed and also designates the distribution order of the search request information. A <Host> element designates a host address. A host to which the search request information should be distributed at an earlier timing is placed above in accordance with the distribution order. The last value of the <Querypath> element stores the host address of the host itself which has created the search request information. Referring to FIG. 4, the message is distributed from the host having a host address “192.168.10.127” to the host having a host address “192.168.10.125” first. Next, the message is distributed to the host having a host address “192.168.10.15” and finally to the self host “192.168.10.127”.

If the <QueryPath> element is blank, the transmission targets are not specified. Hence, the search request information is not distributed to the remaining hosts.

<TransmissionFailure> is an element tag which stores delivery disable information. It stores the information of a host when the message transmission to the target host has failed due to, e.g., a transmission error in the process of distributing the search request information. Referring to FIG. 4, this element is blank because no transmission disable host is present yet. <QueryInfo> is an element tag which describes the search request of the search request information and has elements <Keyword>, <BooleanCondition>, and <MediaType>.

<Keyword> designates the search request keyword of the search request information. A plurality of <Keyword> elements can be described simultaneously. Referring to FIG. 4, two keywords “Computer” and “Virus” are designated. <BooleanCondition> designates a search condition for the keywords designated by the <Keyword> elements. <BooleanCondition> can designate “AND” to designate the AND of keywords or “OR” to designate the OR of keywords. <MediaType> designates the media type of information to be searched for. <MediaType> can designate “Text” to designate a text file, “Image” to designate an image file such as a bitmap image or compressed image, “Movie” to designate a moving image file, or “None” to designate no specific media type.

<ReturnAddress> designates destination host information to which the result of information search for the search request information should the returned. Referring to FIG. 4, the host “192.168.10.127” as the search request transmission source is designated as the return destination. The information search result by each host is returned to “192.168.10.127”.

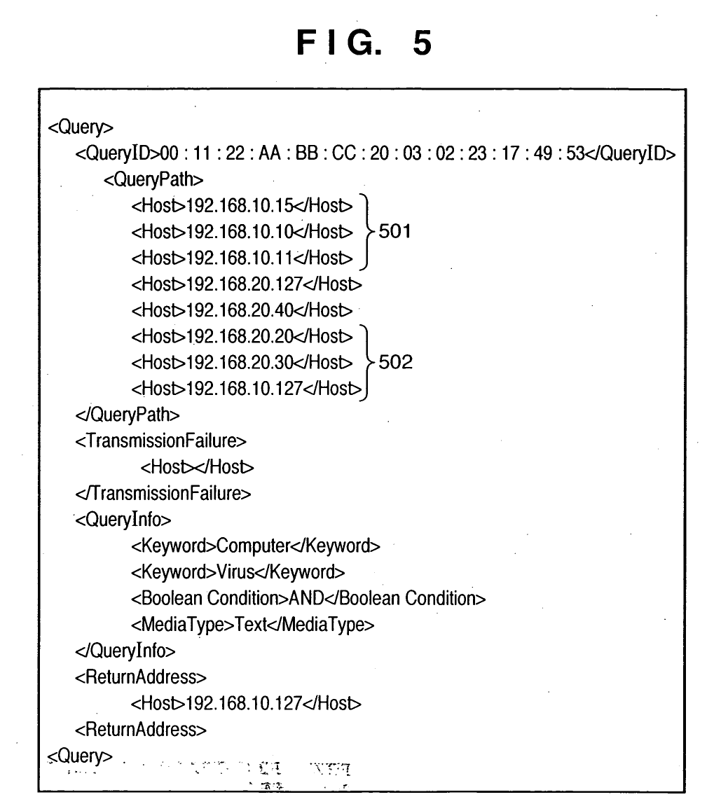

FIG. 5 shows a distributed information search request. This message is transmitted to “Host15” having a host address “192.168.10.15” from “Host125” with a host address “192.168.10.125” after “Host125” receives the search request information message according to the embodiment of the present invention shown in FIG. 4.

Referring to FIG. 5, Host125 deletes <Host>192.168.10.125</Host> related to itself and updates the search request information message such that <Host>192.168.10.15</Host> to which the message should be transmitted is placed on the top. Host125 transmits the message to the host for which search is to be executed next and also transmits the same distributed search request message to the host terminal described by <ReturnAddress>. Accordingly, the host terminal described by <ReturnAddress> can easily grasp the progress state of distributed search.

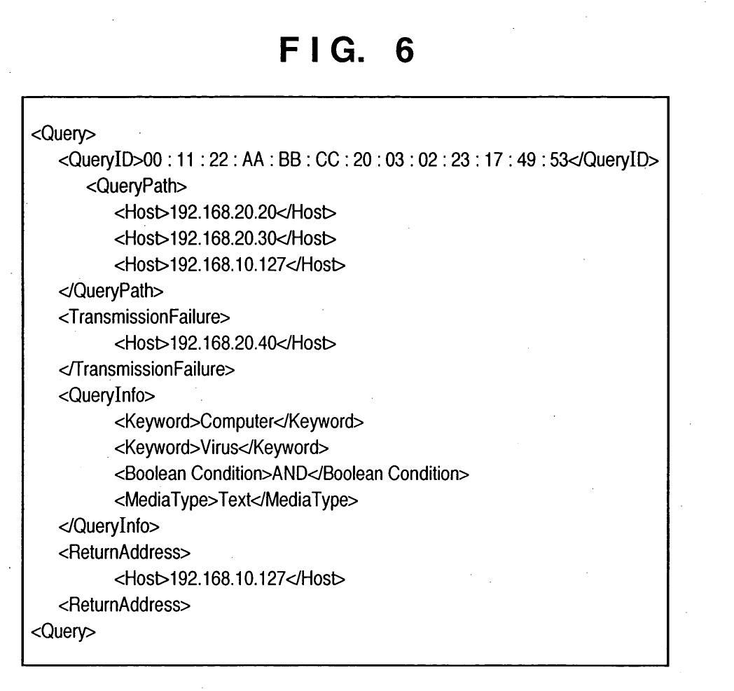

FIG. 6 shows search request information. After search is ended up to Host 501 in <QueryPath> shown in FIG. 5, the search request information according to the embodiment shown in FIG. 4 is received by “SV001” having a host address “192.168.20.127”. Then, an attempt to transmit the search request information to “CL003” having a host address “192.168.20.40” is made. However, a transmission error is detected, and the transmission to the host “CL003” has failed. At this time, the search request information shown in FIG. 6 is transmitted to the next host “CL001”.

Referring to FIG. 6, the host “SV001” deletes <Host>192.168.20.127</Host> related to itself from the <QueryPath> information and also deletes <Host>192.168.20.40</Host> representing the next host for which the transmission has failed. The host “SV001” also updates the search request information message such that the next host information <Host>192.168.20.20</Host> is placed on the top (a portion 502 in <QueryPath> shown in FIG. 5 remains). In addition, the host “SV001” sets the host information <Host>192.168.20.40</Host> for which the transmission has failed is set as the value of the <TransmissionFailure> element and transmits the information to the next host.

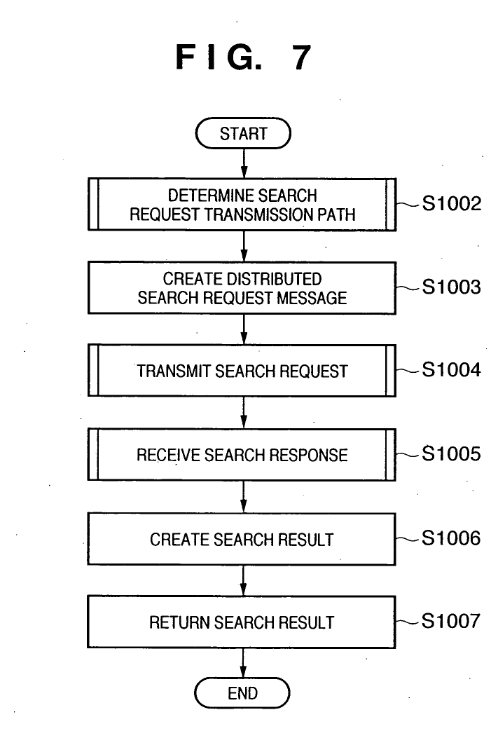

Distributed information search processing executed in this embodiment will be descried next with reference to the flowcharts shown in FIGS. 7 to 15.

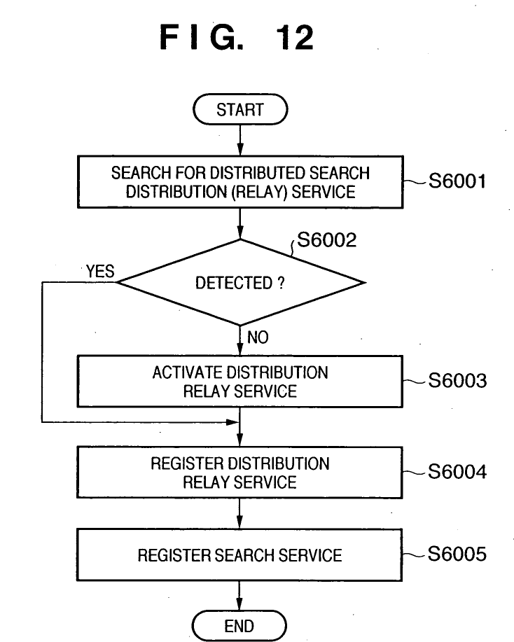

FIG. 12 is a flowchart showing search information distribution service activation processing executed in the embodiment. This is processing of a distributed information search apparatus with a relatively low capability on the network, to which a user-side client terminal has transmitted a search request.

When a user-side client terminal receives a search information distribution request to a distributed information search apparatus on the network, an apparatus having a search request information distribution service and capable of executing distributed search relay is searched for in step S6001. To search for the distributed search relay apparatus, the search service broadcasts an inquiry message to all hosts on the network. Upon receiving the inquiry message, the distributed search relay apparatus transmits a response message to the calling host having the search service.

In step S6002, it is determined whether a response message is received from another distributed search relay apparatus in response to the inquiry message broadcast in step S6001. If no response message is received within a predetermined time, it is determined that no distributed search relay apparatus is present, or the request is rejected, and the flow branches to step S6003. If YES in step S6002, the flow branches to step S6004.

If it is determined in step S6002 that no distributed search relay apparatus is present, the self host which holds the search service activates the distributed search request information distribution service and starts the search relay service to the remaining hosts in step S6003.

In step S6004, the host which holds the search request information distribution service and has returned the response message in step S6002 or the self host which holds the distributed search request information distribution service activated in step S6003 is stored in a storage area (not shown) of the search service as the search request transmission destination in this search service.

In step S6005, the self host which holds the search service is registered in the host management information described in detail in FIG. 3 which is held by the distributed search relay apparatus. If an inquiry message from another host on the network is received after the start of the distributed search information distribution service in step S6003, a response message is returned in response to the inquiry message. In addition, the information of the host which has transmitted the inquiry message is registered in the host management information.

If YES in step S6002, the flow advances to step S6006 to transfer information about the search request from the client to the distributed search apparatus which has transmitted the response message. The distributed search apparatus which has transmitted the response message starts the distributed search information distribution service on the basis of the transferred information about the search request, and executes the same processing as in steps S6003 to S6005.

Processing of the distributed information search system will be described next.

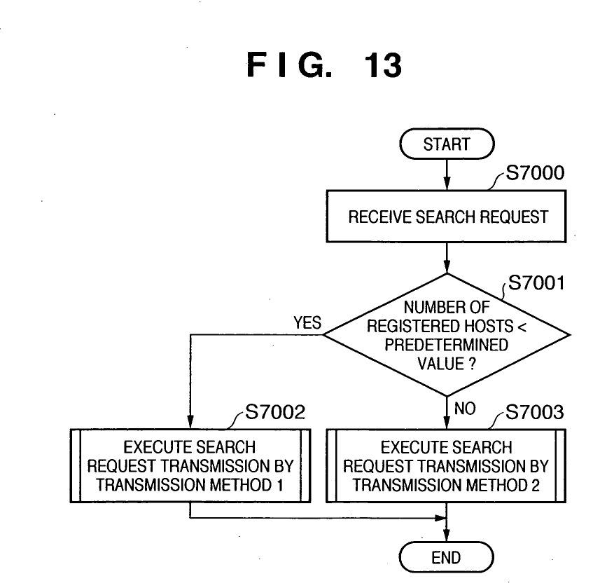

FIG. 13 is a flowchart showing processing of a service to select a distributed search path of distributed information search and control distribution, which is executed by the distributed search apparatus determined as the distributed search apparatus which should start the distributed search information distribution service.

In step S7000, search request information is received. In this search request information reception, a search request containing a search keyword and search condition designated by the user in FIG. 2 is received in accordance with a predetermined communication protocol.

In step S7001, it is determined whether the number of hosts stored in the host management information described in detail in FIG. 3 is smaller than a predetermined value (e.g., 128). If YES in step S7001, search request transmission processing by search request information transmission method 1 is done in step S7002. If NO in step S7001, search request transmission processing by search request information transmission method 2 is done in step S7003. As the condition for branching, not the number of hosts but the distribution load on the search relay apparatus may be determined.

Step S7002 is search request distribution transmission processing by search request transmission method 1. This will be described in detail with reference to FIG. 7.

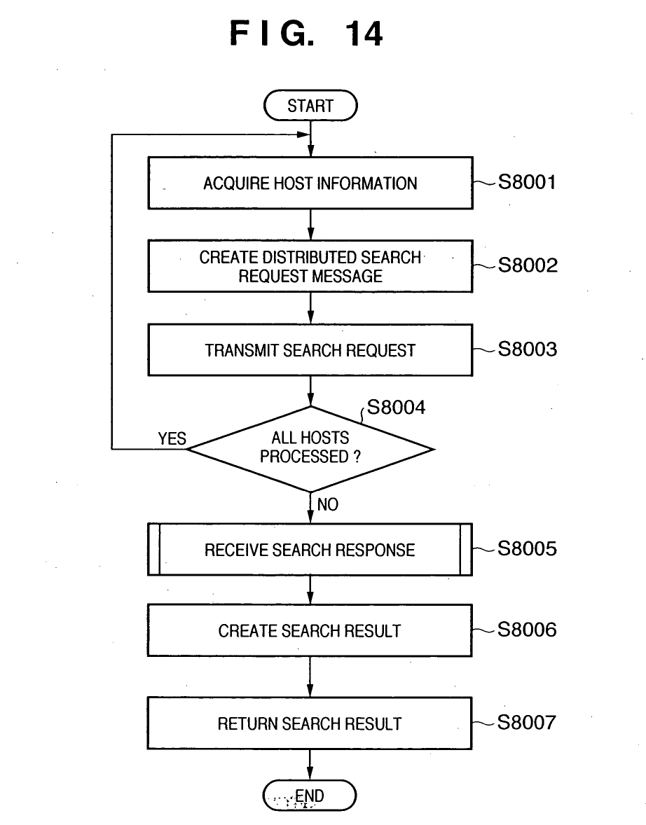

Step S7003 is search request distribution transmission processing by search request transmission method 2. This will be described in detail with reference to FIG. 14.

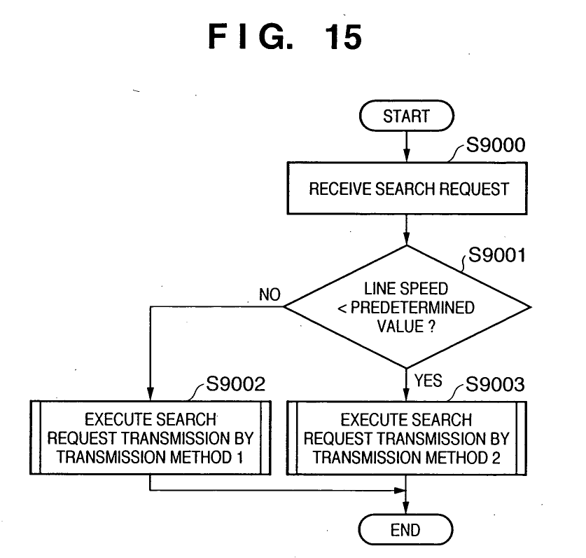

FIG. 15 is a flowchart showing processing executed by the service to select a distributed search path of distributed information search and control distribution, which is executed in another embodiment.

In step S9000, a search request is received. This distributed information search request reception is a known technique widely executed by a search apparatus of the same kind. In this processing, a search request containing a search keyword and search condition designated by the user in FIG. 2 is received in accordance with a predetermined communication protocol.

In step S9001, it is determined whether the connection line speed type 305 stored in the host management information described in detail in FIG. 3 is smaller than a predetermined value (e.g., 100 Mbps). If YES in step S9001, search request transmission processing by search request information transmission method 1 is done in step S9002. If NO in step S9001, search request transmission processing by search request information transmission method 2 is done in step S9003.

Step S9002 is search request distribution transmission processing by search request transmission method 1. This will be described in detail with reference to FIG. 7.

Step S9003 is search request distribution transmission processing by search request transmission method 2. This will be described in detail with reference to FIG. 14.

FIG. 7 is a flowchart showing processing by transmission method 1 executed by the service to select a distributed search path of distributed information search and control distribution. This processing is executed by the distributed search apparatus determined as the distributed search apparatus which should start the distributed search information distribution service.

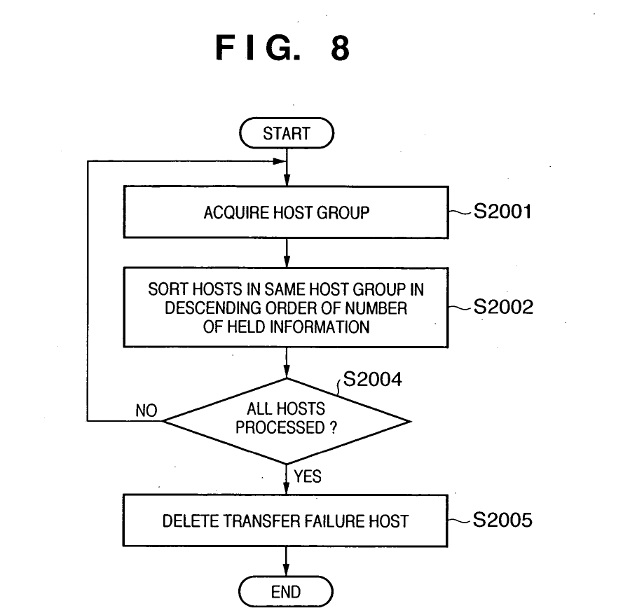

In step S1002, a host which should process the search request received in step S7000 is selected, and the path to transmit the search request message is determined. The search request transmission path determination processing will be described later in detail with reference to FIG. 8.

In step S1003, the <QueryInfo> element is created from the search request received in step S7000. The <QueryPath> element is also created from the search request transmission path determined in step S1002. In addition, the MAC address and creation time provided by the NIC 19 are acquired to generate the <QueryID> element data. The <TransmissionFailure> element is added. The host address of the self host is set in the <ReturnAddress> element, thereby creating a search request information message.

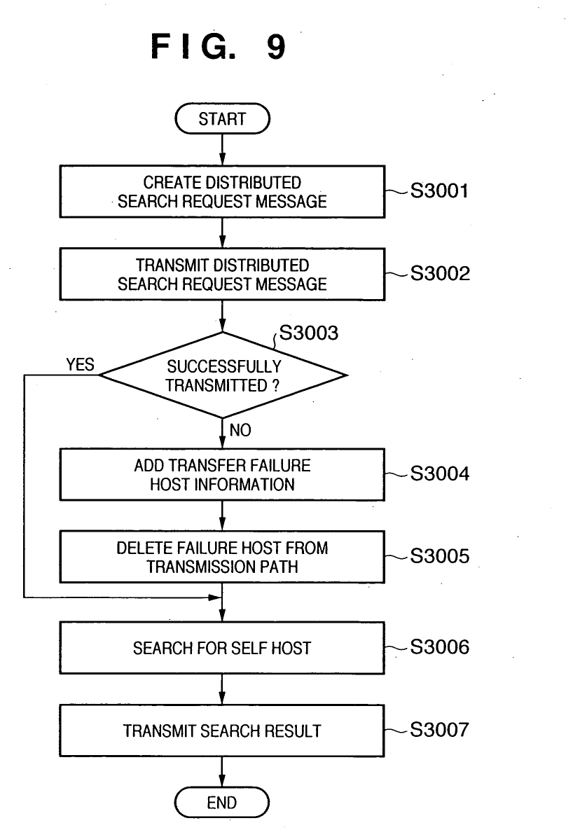

In step S1004, the search request information message is transmitted to the host on the top of the path in accordance with the search request transmission path determined in step S1002. The search request transmission processing will be described later in detail with reference to FIG. 9.

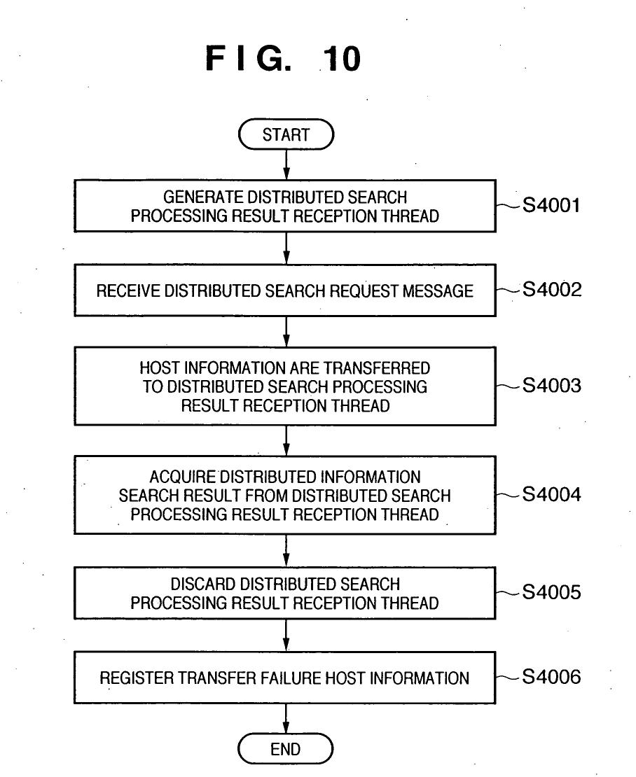

In step S1005, responses of search processing results from the respective hosts are received. The search response reception processing will be described later in detail with reference to FIG. 10.

In step S1006, the search results received in step S1005 from the respective hosts are integrated. Each search result is uniquely identified by URI which represents the location of information contained in the search result returned from the host. The search results are integrated while avoiding overlap of URI in them and sorted in descending order of search score.

In step S1007, the search result integrated in step S1006 is transmitted to the host which has issued the search request received in step S7000. The distributed information search processing is thus ended.

The search request transmission path determination processing in step S1002 will be described next in detail with reference to FIG. 8.

FIG. 8 is a flowchart showing details of the search request transmission path determination processing by transmission method 1 in the distributed search apparatus determined to start the distributed search information distribution service.

In step S2001, the host management information described in detail in FIG. 3 is searched to acquire pieces of host information which belong to each host group with the same host group 303.

In step S2002, the pieces of host information acquired in step S2001 are sorted in descending order of the number 304 of held information. The distribution order in the same host group is determined and added to the search request transmission path.

In step S2004, it is checked whether all pieces of host information in the host management information are processed. If YES in step S2004, the processing is ended. If unprocessed host information remains, the flow returns to step S2001 to determine distribution for the next host group.

In step S2005, transfer disable host information is read out from a transfer failure host information memory (not shown). If host information stored as a transfer disable host is present, it is deleted from the search request transmission path.

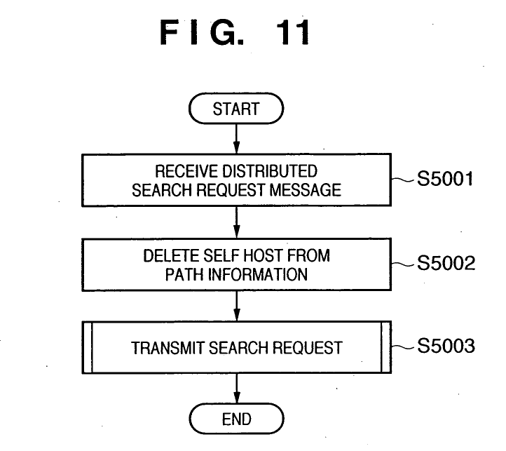

FIG. 9 is a flowchart showing details of search request transmission processing in step S1004 in FIG. 7 and step S5003 in FIG. 11 (to be described later), which is executed by the distributed search apparatus determined as the distributed search apparatus which should start the distributed search information distribution service.

In step S3001, the distributed information search request information message is transmitted to the host indicated by the <Host> element on the top of the <QueryPath> element in the search request information message. Message transmission/reception is done in accordance with the widely used TCP/IP protocol.

In step S3003, it is checked whether transmission to the host has successfully be done. If YES in step S3003, the flow branches to step S3006. If NO in step S3603, the flow advances to step S3004. Whether the transmission has successfully be done is determined by receiving an ACKNOWLEDGE message. The ACKNOWLEDGE message is sent to the transmission source host in, distributed search request message reception processing to be described later with reference to FIG. 11 when the information is normally received.

If NO in step S3003, the host information of the transmission failure is added to the <TransmissionFailure> element in the search request information message in step S3004. In step S3005, the host information of the transmission failure is deleted from the value of the <QueryPath> element in the distributed search request information message. The distributed search request message is transmitted to the host terminal to which the message should be transmitted next.

In step S3006, information search processing of the self host is executed in accordance with information indicated by the <QueryInfo> element in the distributed search request information. The information search processing of the self host is a known technique widely executed, and a detailed description thereof will be omitted.

In step S3007, the search processing result of the self host in step S3006 is transmitted to the host address indicated by the <ReturnAddress> element in the distributed search request information message. The search processing result is also transmitted by storing the search result data in a TCP packet in accordance with the TCP/IP protocol.

FIG. 10 is a flowchart showing details of search response reception processing in step S1005 in FIG. 7, which is executed by the distributed search apparatus determined as the distributed search apparatus which should start the distributed search information distribution service.

In step S4001, a reception thread to receive the search result response from each host is generated. In the reception thread, each transmitted search result is received. In step S4002, the distributed search request information message having the value set in the < > element in the distributed search request information created in step S1003 in FIG. 7 is received. On the basis of this search request message, the host terminal at the request source can notify the client terminal of the progress status of distributed search.

In step S4002, the distributed search request information message is received. After that, in step S4003, of the search hosts determined in step S1002, pieces of host information except those stored in the <TransmissionFailure> element in the received search request information message are transferred to the reception thread in step S4001.

The distributed search processing result reception thread executes reception and standby until search results from all hosts, which are transferred in step S4003, are received. When search results from all hosts are received, the distributed information search results are transferred to the search response reception main process in step S4004.

The search response reception main process receives the distribute information search results from the reception thread and discards the reception thread.

In step S4006, transfer failure host information indicated by the <TransmissionFailure> element in the distributed search request information message is stored in a transfer failure host information memory (not shown).

FIG. 11 is a flowchart showing details of distributed search request information message reception processing executed by a distributed search apparatus other than the distributed search apparatus determined to start the distributed search information distribution service.

In step S5001, reception of a distributed search request information message from another host is waited, and the search request message is received.

In step S5002, the self host information on the top of the host information list of the <QueryPath> element in the distributed search request information distribution service is deleted from the <QueryPath>element.

In step S5003, the search request information message is transmitted to the host on the top of the <QueryPath> element in the search request information message. This search request transmission processing is the same as that described in detail in FIG. 9.

FIG. 14 is a flowchart showing processing by transmission method 2 executed by the service to select a distributed search path of distributed information search and control distribution.

In step S8001, a piece of host information registered in the host management information described in detail in FIG. 3 is acquired.

In step S8002, the <QueryInfo> element is created from the search request received in step S7000. The <QueryPath> element is set as a blank element. In addition, the MAC address and creation time provided by the NIC 19 are acquired to generate the <QueryID> element data. The <TransmissionFailure> element is added. The host address of the self host is set in the <ReturnAddress> element, thereby creating a distributed search request information message.

In step S8003, the distributed search request information message created in step S8002 is transmitted while setting the host information acquired in step S8001 as the transmission destination.

In step S8004, it is determined whether all pieces of host information registered in the host management information described in detail in FIG. 3 are processed. If an unprocessed host remains, the flow returns to step S8001. If the search request information message is transmitted to all hosts, the flow branches to step S8005.

In step S8005, responses of search processing results from the respective hosts to which the message is transmitted in step S8003 are received. The search response reception processing has been described in detail with reference to FIG. 10.

In step S8006, the search results received in step S8005 from the respective hosts are integrated. Each search result is uniquely identified by URI which represents the location of information contained in the search result returned from the host. The search results are integrated while avoiding overlap of URI in them and sorted in descending order of search scores.

In step S8007, the search result integrated in step S8006 is transmitted to the host which has issued the search request received in step S7000. The distributed information search processing is thus ended.

### Modification to First Embodiment

In the first embodiment, the distributed search request information message is created as an XML document described by a text marked up by tags. Instead, binary information which allows identification of each constituent element may be stored in the data packet of a transport layer.

In the above-described embodiment, the search service broadcasts an inquiry message to search for the distributed search path selection service. However, a service directory which manages the service location may be prepared. In this case, each service is registered in the service directory, and service location information is acquired from the directory.

In the above-described embodiment, the distributed information search request message transmission method in the distributed search path selection service is determined on the basis of the number of registered host information on the network. Instead, the determination may be done on the basis of an element other than the number of registered host information, and for example, the line speed of the network or the calculation processing capability or processing load of the host.

The technical principles of the above-described embodiment are not limited to detection processing and can also be applied to another processing. More specifically, in the network system, a terminal apparatus which has received a predetermined processing request inquires of the remaining terminal apparatuses about their capabilities to execute the processing. Each terminal apparatus which has received the inquiry determines in consideration of the memory utilization state or CPU availability whether the load necessary for processing the received job is a predetermined amount and returns the determination result. If a terminal apparatus capable of receiving the predetermined processing request exists, it is transmitted to the terminal apparatus. If no terminal apparatus can receive the predetermined processing request, the terminal apparatus which has received it executes the predetermined processing.

### Second Embodiment

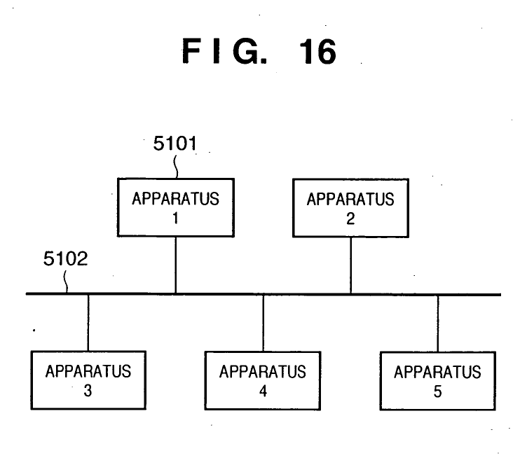

FIG. 16 shows the network arrangement of a distributed search system to which the second embodiment is applied. Referring to FIG. 16, a plurality of information processing apparatuses 5101 are connected through a local area network 103. A plurality of apparatuses are connected to the network. Each apparatus manages information held in it as a search target. When an operator executes a search operation, a search request is sent to the apparatuses connected to the network so that a result of search in the entire network can be obtained.

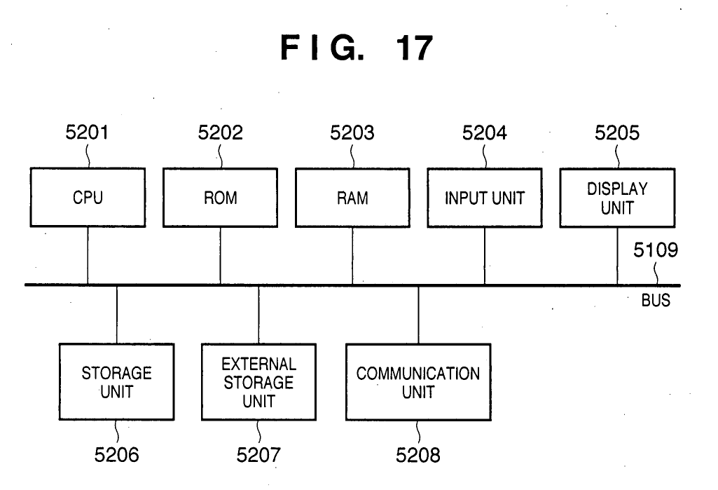

FIG. 17 is a block diagram showing the arrangement of the information processing apparatus 5101 on which the operator executes a search request operation. A central processing unit 5201 executes operations and logic determinations for document search and controls constituent elements connected to a bus 5209 through it. A read only memory 5202 stores the control program to be executed in this embodiment. A random access memory 5203 is used to temporarily store various kinds of data.

An input unit 5204 includes a keyboard and mouse. A display unit 5205 displays document data or graphic data. A storage unit 5206 includes a hard disk. An external storage unit 5207 includes a floppy (registered trademark) disk, writable CD, or DVD.

A communication unit 5208 includes a local area network controller and transmits/receives data to/from an external device through a communication line. The bus 5209 transfers an address signal which designates a constituent element to be controlled by the CPU 5201, and a control signal.

The information processing apparatus of this embodiment which includes the constituent elements operates in accordance with an input from the input unit 5204. When input is executed from the input unit 5204, an interrupt signal is sent to the central processing unit 5201. The central processing unit 5201 reads out various kinds of control signals stored in the ROM 5202. Various kinds of control are executed in accordance with the control signals.

In this embodiment, apparatuses 2 to 5 also have the same hardware configuration whose elements are indicated by the same reference numerals as in FIG. 17.

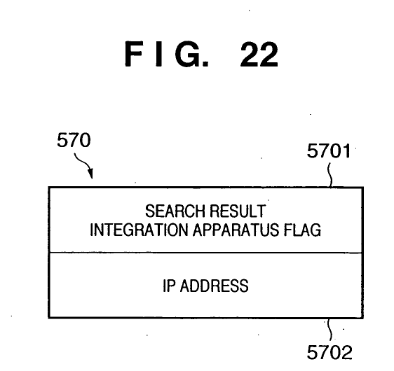

FIG. 22 is an explanatory view showing the storage area of search result integration apparatus information 570 stored in the RAM 5203 of the information processing apparatus 5101. The search result integration apparatus information 570 includes a search result integration apparatus flag field 5701 representing whether an apparatus which provides a search result integration service is present on the network, and an IP address field 5702 which stores the IP address of the apparatus which provides the search result integration service. In the search result integration apparatus flag 5701, “1” is stored when an apparatus which provides the search result integration service is present on the network. Otherwise, “0” is stored.

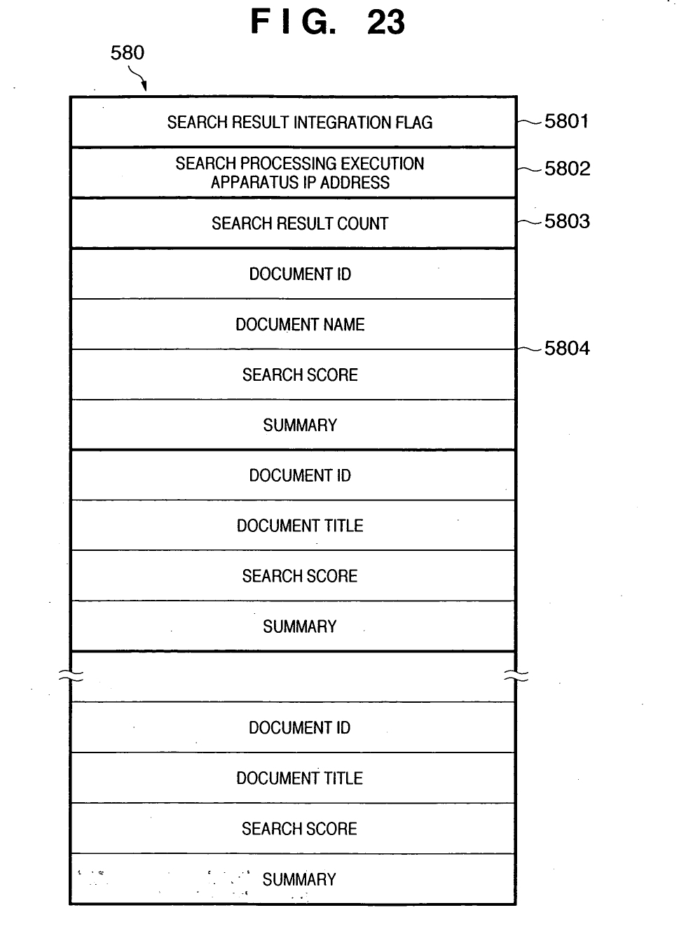

FIG. 23 is an explanatory view showing the storage area of search result information 580 stored in the RAM 5203 of the information processing apparatus 5101. The search result information 580 includes a search result integration flag field 5801 which represents whether the search result is a result obtained by integrating search results from the respective apparatuses by the search result integration service, a search processing execution apparatus IP address field 5802 which stores the IP address of the apparatus which has executed the search processing, a search result count field 5803 which stores the number of search results, and a search result field 5804 which stores the search result.

In the search result integration flag field 5801, “1” is stored when the search result is a result obtained by integrating search results from the respective apparatuses by the search result integration service. Otherwise, “0” is stored. The search result field 5804 stores information of a document ID, document name, search score, and summary. A summary is stored only when “1” is stored in the search result integration flag field 5801.

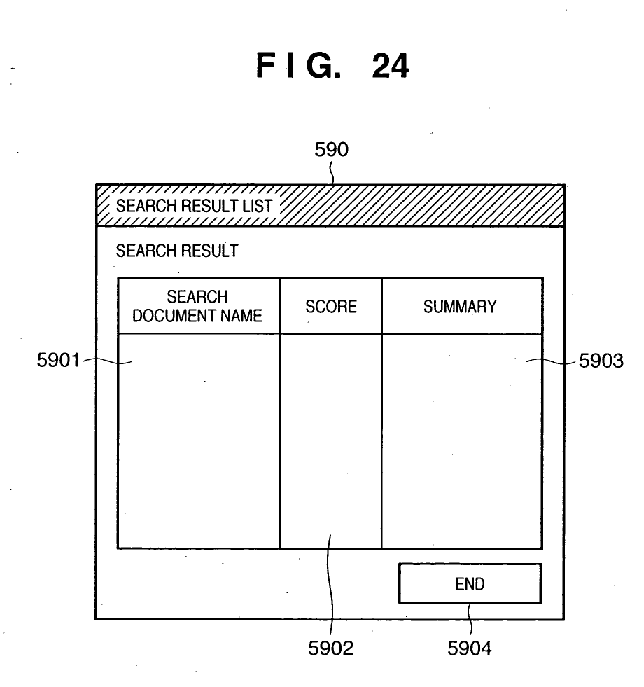

FIG. 24 is an explanatory view of a search result display window 590 which displays the search result on the display unit 5205 of the information processing apparatus 5101. The window includes a document name display portion 5901 which displays the document names of search result documents, a search score display portion 5902 which displays search scores, a summary display portion 5903 which displays the summaries of the search result documents, and an end button 5904 to end the search result display window. If no summary is stored in the summary information of the search result field 5804 of the search result information 580, the summary display portion 5903 is not displayed.

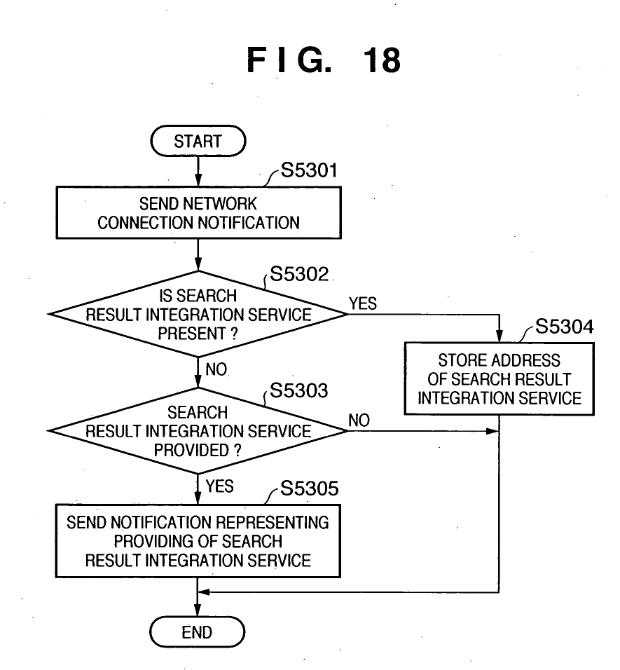

FIG. 18 is a flowchart of processing executed by the CPU 5201 of the information processing apparatus 5101 in participating in the network. To cause the information processing apparatus 5101 to participate in the network, the assigned IP address is sent to each of the remaining apparatuses connected to the network as a network participation notification (S5301). First, the remaining information processing apparatuses are notified of whether an apparatus having a capability of providing the search result integration service and receiving a service is present on the connected network (S5302). If YES in step S5302, “1” is stored in the search result integration apparatus flag field 5701 of the search result integration apparatus information 570 in the RAM 5203. The IP address of the apparatus which provides the search result integration service is stored in the IP address field 5702. Then, the network participation processing is ended (S5304). From this time, the information processing apparatus 5101 temporarily transmits a search result of the information processing apparatus 5101 to the apparatus which provides the search result integration service and receives an integrated result.

If NO in step S5302, it is determined whether the information processing apparatus 5101 connected to the network provides the search result integration service by itself (S5303). If YES in step S5303, the IP address assigned to the information processing apparatus 5101 is transmitted to the remaining connected apparatuses as the apparatus which provides the search result integration service. Then, “1” is stored in the search result integration apparatus flag field 5701 of the search result integration apparatus information 570 in the RAM 5203. The IP address assigned to the information processing apparatus 5101 itself is stored in the IP address field 5702. The network participation processing is thus ended (S5305). If NO in step S5303, no apparatus which provides the search result integration service is present on the connected network. Hence, “0” is stored in the search result integration apparatus flag field 5701 of the search result integration apparatus information 570 in the RAM 5203, and the network participation processing is ended.

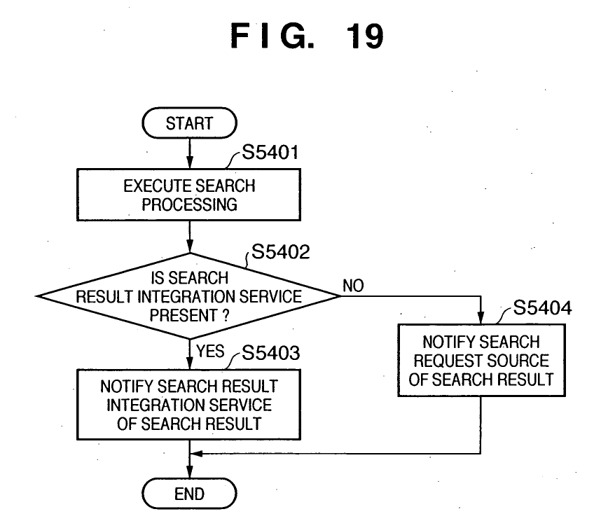

FIG. 19 is a flowchart of search processing executed by the CPU 5201 of the information processing apparatus 5101. Upon receiving a search request for another apparatus connected to the network, the information processing apparatus 5101 executes search processing in accordance with the search request (S5401). In this search processing, “0” is stored in the search result integration flag field 5801 of the search result information 580 in the RAM 5203. The IP address assigned to the information processing apparatus 5101 itself is stored in the search processing execution apparatus IP address field 5802. The number of search results is stored in the search result count field 5803. Search results obtained by the search processing are stored in the search result field 5804. After the end of search processing, it is determined whether an apparatus which provides the search result integration service is present on the network by referring to the search result integration apparatus flag field 5701 of the search result integration apparatus information 570 stored in the RAM 5203 (S5402). If YES in step S5402, the search result information 580 obtained in step S5401 is transmitted to the IP address stored in the IP address field 5702 of the search result integration apparatus information 570 stored in the RAM 5203. Then, the search processing is ended (S5403). If NO in step S5402, the search result information 580 obtained in step S5401 is transmitted to the apparatus which has issued the search request. Then, the search processing is ended (S5404).

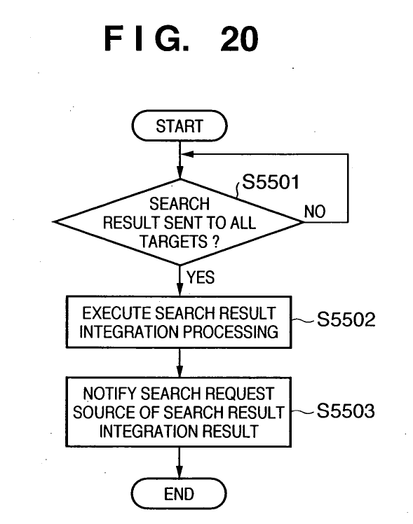

FIG. 20 is a flowchart of search result integration processing which is executed by the CPU 5201 of an information processing apparatus (one of apparatuses 1 to 5 shown in FIG. 16) which provides the search result integration service to the remaining apparatuses connected to the network.

It is determined whether the search result information 580 is collected from the target apparatuses connected to the network (S5501). The search result information 580 collected from each apparatus is stored in the RAM 5203 as search result information of each apparatus. If YES in step S5501, the pieces of search result information 580 of the apparatuses, which are stored in the RAM 5203, are integrated into one search result information 580 and stored in the RAM 5203 (S5502).

When the pieces of search result information 580 are integrated, “1” is stored in the search result integration flag field 5801 of the search result information 580. The summary of the document is generated from the search result document and stored in the summary field of the search result field 5804 of the search result information 580. It is determined whether documents of the same contents are present in the search result documents collected from the plurality of apparatuses. If excess documents are present, they are deleted from the search result information 580. The search result information 580 stored in the RAM 5203 is transmitted to the search request source (information processing apparatus 5101) (S5503). When the information processing apparatus 5101 executes the search result integration service, the processing is ended without executing the processing in step S5503.

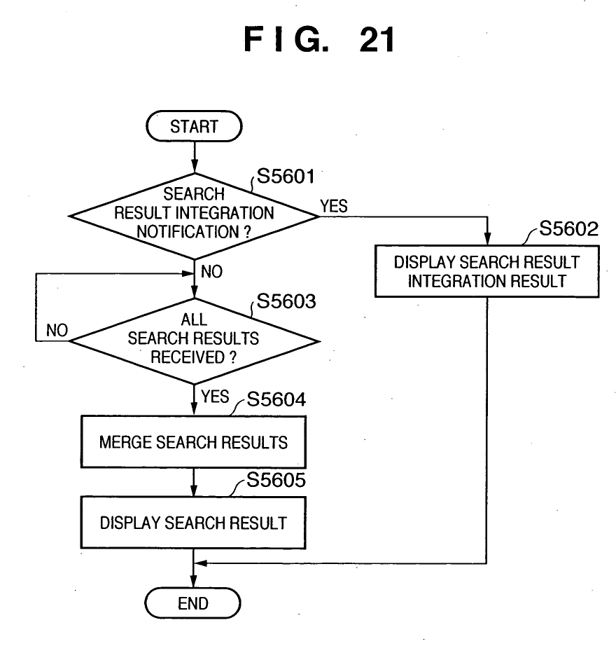

FIG. 21 is a flowchart of search result display processing executed by the CPU 5201 of the information processing apparatus 5101 which has issued the search request. It is determined whether the received search result is a search result sent by the search result integration service (S5601). If YES in step S5601, the search result display window 590 is displayed on the display unit 5205 of the information processing apparatus 5101 on the basis of the received search result. The search result display processing is thus ended (S5602). If NO in step S5601, it is determined whether search results are collected from the target apparatuses connected to the network (S5603).

If YES in step S5603, the pieces of collected search result information 580 of the respective apparatuses are merged and stored in the RAM 5203 of the information processing apparatus 5101 (S5604). The search result display window 590 is displayed on the display unit 5205 on the basis of the search result information 580 stored in the RAM 5203 of the information processing apparatus 5101. The search result display processing is thus ended.

With the above-described arrangement, an apparatus which is rich in resources such as the CPU and memory can provide the search result integration service that requires the resources. When it is determined whether a search service to provide the search result integration service is present, it can be determined whether an apparatus which provides the search result integration service is connected to the network. If the search service to provide the search result integration service is present, a search result processed by the apparatus which provides the search result integration service can be presented to the operator. If no search service to provide the search result integration service is present, search result integration can executed by simply merging the search results from the respective apparatuses connected to the network without requiring many resources such as the CPU and memory, and the search result can be presented to the operator.

Accordingly, even when a specific apparatus is not participating in the network, the search result can be presented to the operator.

In the above-described embodiment, it is confirmed in participating in the network whether the distributed search request information distribution service is present. If no service is present, the search result integration service is started. However, the embodiment is not limited to this. It may be confirmed in transmitting or receiving a search request and participating in the network whether the distributed search request information distribution service is present. If no service is present, the search result integration service is started. In this case, confirmation is done in step S5402 in FIG. 19. If it is determined that no search result integration service is present, the search result integration service is started in step S5404 without sending the search result to the search request source. The search result is subjected to merging.

As described above, an arrangement of the embodiments are also achieved by supplying a storage medium which stores software program codes to implement the functions of the embodiments to a system or apparatus, and causing the computer of the system or apparatus to read out and execute the program codes stored in the storage medium.

In this case, the program codes read out from the storage medium implement the functions of the embodiments, and the storage medium which stores the program codes constitutes the present invention.

As the storage medium for supplying the program codes, a floppy (registered trademark) disk, hard disk, magnetooptical disk, CD-ROM, DVD-ROM, memory card, or the like can be used.

The functions of the embodiments are implemented not only when the readout program codes are executed by the computer but also when the operating system running on the computer performs part or all of actual processing on the basis of the instructions of the program codes, the program codes read out by the processing are written in the memory of a function expansion board inserted into the computer or a function expansion unit connected to the computer, and the central processing unit of the function expansion board or function expansion unit performs part or all of actual processing on the basis of the instructions of the program codes.

As many apparently widely different embodiments of the present invention can be made without departing from the spirit and scope thereof, it is to be understood that the invention is not limited to the specific embodiments thereof except as defined in the appended claims.

Claim of Priority

This application claims priority from Japanese Patent Application Nos. 2003-427618 filed on Dec. 24, 2003 and 2004-177057 filed on Jun. 15, 2004, which are hereby incorporated by reference herein.

1. An information processing method executed by, of a plurality of terminals present on a network, a terminal which receives a predetermined processing request, comprising:
a search step of searching for a terminal capable of executing the predetermined processing; and
a step of causing the terminal which has received the predetermined processing request to execute the predetermined processing by itself on condition that no terminal capable of executing the predetermined processing is detected in the search step.

2. The method according to claim 1, wherein the predetermined processing is search relay processing to distribute search request information to the plurality of terminals in accordance with the received predetermined processing request.

3. The method according to claim 2, wherein in the search step, a terminal capable of executing the search relay is searched for by causing the terminal which has received the predetermined processing request to transmit an inquiry to the plurality of terminals and detect a response.

4. The method according to claim 1, further comprising a step of registering the terminal which executes the predetermined processing.

5. The method according to claim 1, wherein the predetermined processing is processing for integrating results of search processing executed by the plurality of terminals.

6. An information processing terminal which receives a predetermined processing request in a plurality of terminals present on a network, comprising:
a search device which outputs a message to search for a terminal capable of executing the predetermined processing; and
a processing device which causes the terminal which has received the predetermined processing request to execute the predetermined processing by itself on condition that no terminal capable of executing the predetermined processing is detected by said search device.

7. The terminal according to claim 6, wherein the predetermined processing is search relay processing to distribute search request information to the plurality of terminals in accordance with the received predetermined processing request.

8. The terminal according to claim 6, wherein said search device searches for a terminal capable of executing the search relay by causing-the terminal which has received the predetermined processing request to transmit a message to the plurality of terminals and detect a response.

9. The terminal according to claim 6, further comprising registration means for registering the terminal which executes the predetermined processing.

10. The terminal according to claim 6, wherein the predetermined processing is processing for integrating results of search processing executed by the plurality of terminals.

11. A program making a computer execute an information processing method of claim 1.

12. A computer-readable storage medium storing a program of claim 11.
